(19) United States
(12) Patent Application Publication
(10) Pub. No.: US 2005/0186384 A1
(43) Pub. Date: Aug. 25, 2005

(54) Ornamental bow with magnetic attachment portion

(75) Inventor: Abraham Damast, Great Neck, NY (US)

Correspondence Address: Dickstein Shapiro Morin & Oshinsky LLP;41st Floor, 1177 Avenue of the Americas, New York, NY, 10036-2714, US

(73) Assignee: Commodore Manufacturing Corporation, Brooklyn, NY (US)

(21) Appl. No.: 10/783,925

(22) Filed: Feb. 20, 2004

(51) Int. Cl. B32B 3/06

(52) U.S. Cl. 428/99

(57) ABSTRACT

A bow includes: a length of material folded to form a knot portion, a plurality of folds extending from the knot portion, and a magnetic attachment structure permanently affixed to the bow.

### BACKGROUND OF THE INVENTION

1. Field of the Invention

This invention relates to decorative items, and more particularly, to a decorative bow, in particular a medium to large size bow, formed from a length of material and a portion designed to allow for attachment of the bow to surfaces, and particularly metal doors, to be decorated.

2. Description of the Related Art

Bows made of strips of fabric or the like are well known for providing festive decorations for holidays and celebrations. However, there has been a problem with securely affixing the bows to doors, particularly metal doors. In the prior art it is known to use a sticky material stapled to the underside of the bow. This technique is has certain disadvantages for use on metal doors. For one thing, if an extremely sticky adhesive is used, an unsightly residue of the adhesive may be left on the door when the bow is removed. If a weak adhesive is used, the bow will only remain affixed for a limited period of time. Moreover, if the door is dirty, the presence of this dirt will severely reduce the effectiveness of the adhesive.

Another known method of decorating doors is to hang an item over the top of the door. However, this has several disadvantages, not the least of which is that a tight fitting door will not close properly in the presence of such a hanger.

Also, because doors typically present a large flat surface without projections, other than the door knob, it is particularly difficult to attach bows by other known means, such as by tying with string or with streamers of the bow itself. Moreover, many people will attempt to secure bows to doors using a nail. However, this is particularly disadvantageous in that it causes considerable damage to the door.

Thus, there exists a need for a secure method of affixing decorative bows to metal doors that does not suffer from the above disadvantages.

There exists a need for a bow that by its structure would allow it to be affixed to a variety of surfaces and/or structures, while still having a low cost of manufacture and a pleasing appearance.

There also exists a need for a bow that provides flexibility in attachment mechanism to allow for attachment to various surfaces in addition to metal doors.

### SUMMARY OF THE INVENTION

It is an object of the invention to provide a bow structured to allow the bow to be manufactured conveniently and inexpensively.

It is a further object of the invention to provide a bow that has a pleasing and neat appearance and that may securely be affixed to a number of different surfaces, and in particular to metal doors. It is a further object to provide a bow that has alternative attachment portions that allow it to be affixed to most other surfaces as well.

According to an aspect of the invention, there is provided a bow, including a length of material folded to form a knot portion, a plurality of extending folds extending from the knot portion, and a magnetic attachment structure permanently affixed to the bow.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a rear elevational view of a bow formed in accordance with the present invention;

FIG. 2 is a close up view substantially corresponding to the view of FIG. 1; and

FIG. 3 is a front perspective view of the bow in accordance with the present invention.

### DESCRIPTION OF THE PREFERRED EMBODIMENTS

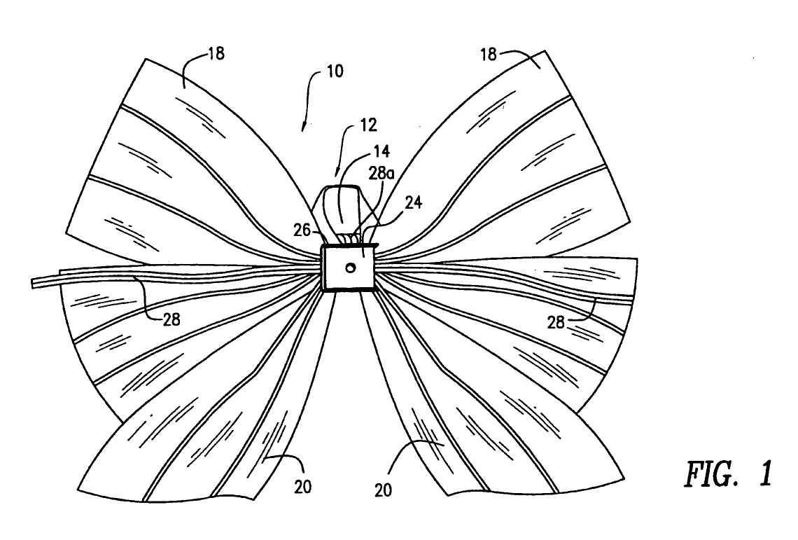

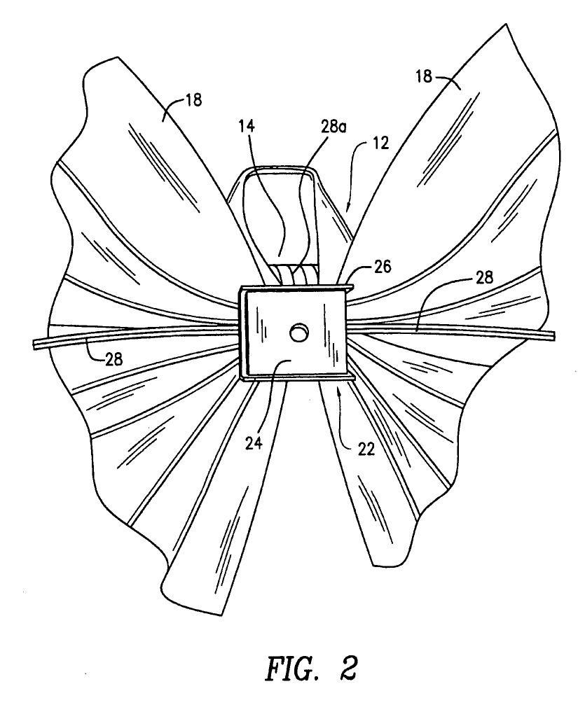

A bow constructed in accordance with the principles of the present invention is shown in the figures. With reference to FIGS. 1 and 2, in the illustrated embodiment, one or more lengths of fabric, or other flexible material, are folded together to form the general shape of the bow 10, the folding being done in the well-known manner. The material is preferably folded to form a knot portion 12, substantially centrally located. A knot support portion 14 is inserted into the knot to maintain the shape of the knot portion 12, and in particular to maintain the shape of the loop of fabric 16 formed by the knot.

The bow further comprises loops 18, extending from the sides of the knot portion 12, and lower streamers 20, which hang down providing a pleasing appearance. It is to be noted that bows of various types may be employed, some having different folds and pleats, without varying from the scope of the present invention.

A magnetized attachment structure 22 is provided at a rear portion of the bow, generally corresponding to the position of the knot portion 12. The magnetized attachment structure 22 is securely affixed, for example by glue, to the bow and functions to permit the bow to be temporarily, yet securely, attached to any metal surface for decoration of that surface.

As can be seen from the figures, in the illustrated embodiment, the magnetized attachment structure 22 is formed of a magnet 24 and a metal magnet holder 26 in which the magnet is secured. The metal magnet holder 26 is preferably formed of metal. In this embodiment, the holder 26 is shaped so as to form a cavity in which the magnet 24 securely resides. The magnet is preferably securely affixed within the cavity by, for example, a strong glue or other adhesive appropriate for bonding metal with metal.

The combination of the holder 26 and the strong adhesive result in an extremely secure attachment of the magnet 22 within the holder 26. In addition, because the holder is made of metal, the magnet 22 has a tendency to stay attached to the holder 26 by magnetic attraction and the metal of the holder also may become magnetic due to contact with the magnet.

The flat back surface of the holder 26 is securely affixed to the bow knot portion by an appropriate adhesive, in the illustrated embodiment. However, as will be understood by those skilled in the art, the holder 26 may also be affixed by other means, such as by a rivet or screw or the like.

Auxiliary attachment structure 28 is preferably provided for providing a more secure attachment, or, as a substitute for the magnetic attachment, for example, where no metal surfaces are available. As can be seen in FIGS. 1 and 2, the auxiliary attachment structure extends from each side of the knot portion and is preferably secured to the knot portion at the same location as the magnetized attachment structure 22. In the illustrated embodiment, the auxiliary attachment structure 28 is a strip, or alternatively, plural strips, of a twist-tie-like material that allows the bow to be tied to any structure around which such tying is possible.

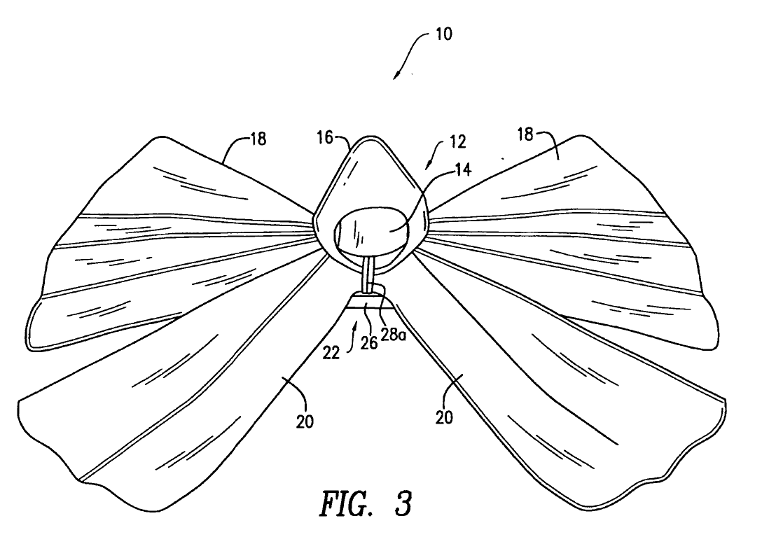

As best seen if FIGS. 2 and 3, in the illustrated embodiment, to provide for a secure connection of the twist-tie-like material to the knot portion, a middle portion 28a of the auxiliary attachment structure 28 is wrapped around the knot of the bow. Preferably, the auxiliary attachment structure 28 is secured to the bow at the same location as the magnetized attachment structure 22, to take advantage of the adhesive already present at that location. However, the structure is not limited to the illustrated embodiment.

The material used for the bow may be of unitary construction, i.e., formed of a single piece of material, or may be a composite, formed of more than one sheet of material sewn together to form the bow.

By virtue of the structure discussed above, and shown in the figures, the bow with attachment structure of the present invention may be affixed to a variety of surfaces, making use of one or more of the attachment structures advantageously provided.

Further, by virtue of the structure discussed above, the bow of the present invention may be attached to a mail basket, in addition to a metal door. The bow may have attached therewith a bouquet of flowers, which would allow the flowers to be attached to a door for Easter, Christmas, Halloween. Additionally, the bow may be a harvest bow with a magnet to hold seasonal attachments. A bunny or an Easter basket can also be used as an attachment to the bow with the magnet to allow placement of those items on a door for decorative purposes to match the season.

In addition to doors, the bow according to the present invention can be affixed to a multitude of other surfaces, including but not limited to, fences, light switches, lamp posts, mailboxes and railings. Further, windows can be decorated because the frames of many windows are metal and the bow will attach securely to such window frames. As will be understood, the present invention can be used either outdoors or indoors. The wire auxiliary attachment structure 28 allows for attachment to many other surfaces, as discussed above.

The material out of which the bow is formed may be any flexible material capable of being folded into a bow shape. An example of such a suitable material would be a fabric, either natural or synthetic, or a combination thereof. The bow of the present invention is preferably of bow of medium to large size, of a type easily visible on a door.

In accordance with the illustrated embodiment of the present invention, the bow 10 includes dual loops 18 extending from each side of the knot portion 12 and streamers 20. Of course, the present invention is not limited to this, or any, ornamentation scheme and any type of bow, including bows with multiple loops and no streamers, or any combination thereof may be used.

Various changes to the foregoing article of manufacture may be introduced without departing from spirit and scope of the present invention. For example, although the illustrated embodiment uses a metal magnet holder, the invention may be made without such a magnet holder. That is, the magnet can be affixed directly to the bow itself, for example by glue.

The above-described embodiments are strictly illustrative in nature and do not limit the invention, the scope of which is defined in the following claims.

1. A bow, comprising:
a length of material folded to form a knot portion,
a plurality of folds extending from the knot portion, and
a magnetic attachment structure permanently affixed to the bow.

2. The bow according to claim 1, wherein the magnetic attachment structure is affixed to the bow in association with the knot portion.

3. The bow according to claim 2, wherein the magnetic attachment structure comprises a magnet and a metal magnet holder in which the magnet resides, the metal magnet holder being affixed to the bow at the knot portion.

4. The bow according to claim 2, wherein the magnetic attachment structure further comprises an auxiliary attachment structure extending from the knot portion.

5. The bow according to claim 4, wherein said auxiliary attachment structure comprises one or more twist ties.

6. The bow according to claim 4, wherein said auxiliary attachment structure comprises one or more strings.

7. The bow according to claim 1, further comprising a knot supporting member, the knot supporting member being structured so as to maintain a shape of a central loop associated with the knot portion.

8. A bow attachable to a metal surface, the bow comprising:
a length of material folded to form a knot portion,
a plurality of folds extending from the knot portion, and
a magnetic attachment structure permanently affixed to the bow, the magnetic attachment structure providing attachment to the metal surface without an adhesive layer between the magnetic attachment structure and the metal surface.

9. The bow according to claim 8, wherein the magnetic attachment structure is affixed to the bow in association with the knot portion.

10. The bow according to claim 9, wherein the magnetic attachment structure comprises a magnet and a metal magnet holder in which the magnet resides, the metal magnet holder being affixed to the bow at the knot portion.

11. The bow according to claim 9, wherein the magnetic attachment structure further comprises an auxiliary attachment structure extending from the knot portion.

12. The bow according to claim 11, wherein said auxiliary attachment structure comprises one or more twist ties.

13. The bow according to claim 11, wherein said auxiliary attachment structure comprises one or more strings.

14. The bow according to claim 8, further comprising a knot supporting member, the knot supporting member being structured so as to maintain a shape of a central loop associated with the knot portion.
